(19) United States
(12) Patent Application Publication
(10) Pub. No.: US 2021/0289356 A1
(43) Pub. Date: Sep. 16, 2021

(54) IN-VEHICLE CONTROL DEVICE

(71) Applicant: TOYOTA JIDOSHA KABUSHIKI KAISHA, Toyota-shi (JP)

(72) Inventors: Koichi OKUDA, Toyota-shi (JP); Atsushi KAMADA, Miyoshi-shi (JP); Atsushi TABATA, Okazaki-shi (JP); Hiroshi SHIBATA, Seto-shi (JP)

(73) Assignee: TOYOTA JIDOSHA KABUSHIKI KAISHA, Toyota-shi (JP)

(21) Appl. No.: 17/161,887

(22) Filed: Jan. 29, 2021

(30) Foreign Application Priority Data
Mar. 12, 2020 (JP) 2020-042807

(51) Int. Cl. H04W 12/069; H04W 12/04; H04W 84/18; H04W 4/40

(52) U.S. Cl. CPC H04W 12/069; H04W 4/40; H04W 84/18; H04W 12/04

(57) ABSTRACT

An in-vehicle control device performs authentication using a variable authentication key when the authentication is requested upon executing a predetermined process involving communication with an external communication server, and executes the predetermined process and stores, as the variable authentication key, at least a part of information on the communication upon executing the predetermined process when the authentication using the variable authentication key is certified. As such, since the in-vehicle control device and the external communication server automatically certify each other's validity using the variable authentication keys, a user does not need to certify the validity, thereby improving the efficiency of the authentication for the communication between a vehicle and the external communication server.

### CROSS-REFERENCE TO RELATED APPLICATION

The application claims priority to Japanese Patent Application No. 2020-042807 filed on Mar. 12, 2020, incorporated herein by reference in its entirety.

### BACKGROUND

### 1. Technical Field

The present disclosure relates to an in-vehicle control device.

### 2. Description of Related Art

An authentication system including a vehicle, a computer, and an authentication server has been proposed (refer to, for example, Japanese Unexamined Patent Application Publication No. 2014-048800). In this authentication system, the vehicle transmits an authentication information request (nonce) to the connected computer. Upon receiving the nonce from the vehicle, the computer generates attestation data, attaches an electronic signature to the attestation data and the nonce, and transmits the attestation data to the authentication server. The authentication server generates authentication information indicating that the computer and its software are validated based on the attestation data, the electronic signature, and the nonce, which are transmitted from the computer, and transmits the authentication information to the vehicle. Then, the vehicle certifies the validity of the computer based on the authentication information transmitted from the authentication server, and permits the communication.

### SUMMARY

In communication between the vehicle and the server without the computer, a method in which a user certifies the validity of the communication is used in order to improve reliability. However, in this case, even when the vehicle connects to a server for which the validity of communication has been certified in the past, the user needs to certify the validity again, which may increase the burden on the user.

An in-vehicle control device of the present disclosure is for improving efficiency of authentication when communication is established between a vehicle and an external communication server.

The in-vehicle control device of the present disclosure employs the following configuration.

The in-vehicle control device according to the present disclosure is an in-vehicle control device that communicates with an external communication server. The in-vehicle control device is configured to, when the authentication is requested upon executing a predetermined process involving the communication with the external communication server, perform the authentication using a variable authentication key, and, when the authentication using the variable authentication key is certified, execute the predetermined process and store, as the variable authentication key, at least a part of information on the communication upon executing the predetermined process.

In the in-vehicle control device according to the present disclosure, when the authentication is requested upon executing the predetermined process involving the communication with the external communication server, the authentication is performed using the variable authentication key, and when the authentication using the variable authentication key is certified, the predetermined process is executed and at least a part of information on the communication upon executing the predetermined process is stored as the variable authentication key. As such, since the in-vehicle control device and the external communication server automatically certify each other's validity using the variable authentication keys, a user does not need to certify the validity, thereby improving the efficiency of the authentication for the communication between a vehicle and the external communication server.

In the in-vehicle control device according to the present disclosure, the variable authentication key is information including at least one of vehicle location information, a communication time with the external communication server, and processing information on the predetermined process.

The in-vehicle control device according to the present disclosure may store a plurality of the variable authentication keys. Consequently, the reliability of the communication can be improved as the communication is authenticated using the plurality of stored variable authentication keys.

In the in-vehicle control device according to the present disclosure, the execution of the predetermined process may be ceased when the authentication cannot be certified a predetermined number of times. Consequently, it is possible to prevent an unauthorized process from being executed when the vehicle communicates with the external communication server.

In the in-vehicle control device according to the present disclosure, a fixed authentication key may be stored at least until shipment of the vehicle, and authentication may be performed using the fixed authentication key when the authentication with the external communication server is requested for the first time. In this case, the fixed authentication key may be stored upon receiving a predetermined command from the external device. Consequently, the authentication is performed using the stored fixed authentication key when the communication with the external communication server is established for the first time before sale of the vehicle by a dealer or at the time of maintenance, thus the communication with the external communication server has improved reliability.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a configuration diagram illustrating a schematic configuration of a cloud server and a hybrid vehicle equipped with an in-vehicle control device as one embodiment of the present disclosure;

FIG. 2 is a flowchart illustrating one example of a processing routine executed by an electronic control unit (ECU);

FIG. 3 is an explanatory diagram illustrating one example of information included in a variable authentication key;

FIG. 4 is an explanatory diagram illustrating one example of a method for authenticating communication between the ECU and the cloud server; and

FIG. 5 is a flowchart illustrating one example of a processing routine executed by the ECU.

### DETAILED DESCRIPTION OF EMBODIMENTS

Hereinafter, embodiments for implementing the present disclosure will be described with reference to examples.

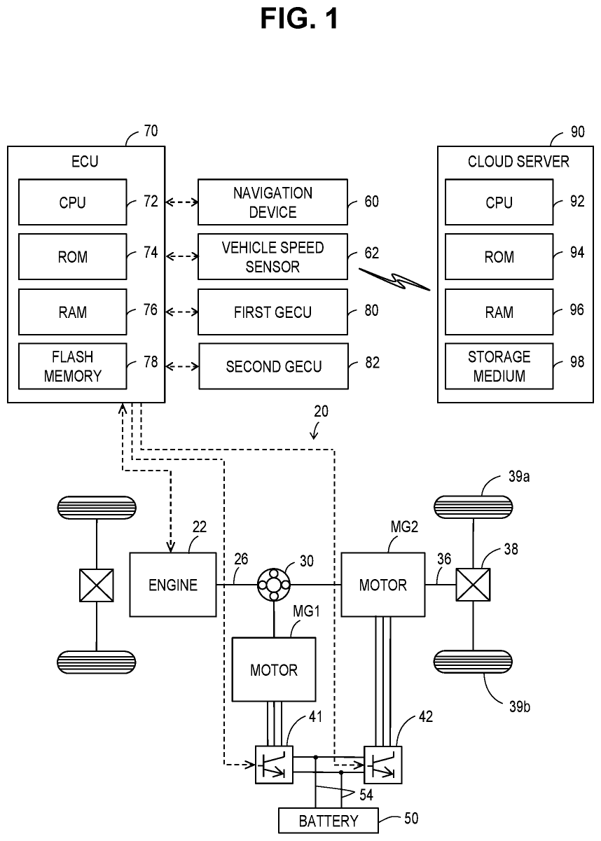

FIG. 1 is a configuration diagram illustrating a schematic configuration of a cloud server 90 and a hybrid vehicle 20 equipped with an in-vehicle control device as one embodiment of the present disclosure. As illustrated, the hybrid vehicle 20 of the present example includes an engine 22, a planetary gear 30, motors MG1, MG2, inverters 41, 42, a battery 50, an electronic control unit (hereinafter referred to as “ECU”) 70. The “in-vehicle control device” mainly corresponds to the ECU 70.

The engine 22 is configured as an internal combustion engine that outputs power using gasoline or light oil as fuel. The operation of the engine 22 is controlled by the ECU 70. The planetary gear 30 is configured as a single pinion planetary gear mechanism. A sun gear of the planetary gear 30 is connected to a rotor of the motor MG1. A ring gear of the planetary gear 30 is connected to a drive shaft 36 that is connected to drive wheels 39a, 39b through a differential gear 38. A crankshaft 26 of the engine 22 is connected to a carrier of the planetary gear 30.

The motor MG1 is configured as, for example, a synchronous generator-motor, and the rotor is connected to the sun gear of the planetary gear 30 as described above. The motor MG2 is configured as, for example, a synchronous generator-motor, and its rotor is connected to the drive shaft 36. The inverters 41, 42 are used to drive the motors MG1, MG2, and are connected to the battery 50 via a power line 54. The motors MG1, MG2 are rotationally driven by the ECU 70 executing switching control of a plurality of switching elements (not shown) of the inverters 41, 42. The battery 50 may be configured as, for example, a lithium-ion secondary battery or a nickel-hydrogen secondary battery, and is connected to the inverters 41, 42 via the power line 54 as described above.

A navigation device 60 includes, although not shown, a device body, a GPS antenna, and a display. The device body has, although not shown, a CPU, a ROM, a RAM, a storage medium, input/output ports, and a communication port. The storage medium of the device body stores map information, traffic congestion information, traffic restriction information, disaster information, and the like. The GPS antenna receives information on a location of the subject vehicle (hereinafter referred to as “location information”). The display is configured as a touchscreen display that displays various information, such as the location information and a planned traveling route to a destination, and allows the user to input various instructions. The navigation device 60 is connected to the ECU 70 via the communication port.

The ECU 70 is configured as a microprocessor centered on a CPU 72, and is provided with a ROM 74 that stores a processing program, a RAM 76 that temporarily stores data, a nonvolatile flash memory 78, input/output ports (not shown), and a communication port (not shown), in addition to the CPU 72. The ECU 70 is connected to the navigation device 60, a first gateway electronic control unit (hereinafter referred to as a “first GECU”) 80, and a second gateway electronic control unit (hereinafter referred to as a “second GECU”) 82, via the communication port.

Signals from various sensors are input to the ECU 70 via the input port. Examples of the signals input to the ECU 70 may include data indicating states of the engine 22 and the motors MG1, MG2, the location information transmitted from the navigation device 60, and vehicle speed V transmitted from a vehicle speed sensor 62. Various control signals are output from the ECU 70 via the output port. Examples of signals output from the ECU 70 may include control signals for the engine 22 and the motors MG1, MG2 (the inverters 41, 42). The ECU 70 is configured to be capable of establishing wireless communication with the cloud server 90 via the first GECU 80. The first GECU 80 may execute, for example, protocol conversion between the ECU 70 and the cloud server 90. The second GECU 82 is configured to be connectable to an external device.

The cloud server 90 is configured as a microprocessor centered on a CPU 92, and is provided with a ROM 94 that stores a processing program, a RAM 96 that temporarily stores data, a storage medium 98 such as an HDD or an SSD, input/output ports (not shown), and a communication port (not shown), in addition to the CPU 92. The cloud server 90 is configured to be capable of establishing wireless communication with the ECU 70 via the first GECU 80 as described above.

The ECU 70 controls the engine 22 and the motors MG1, MG2 (the inverters 41, 42) such that the hybrid vehicle 20 of the present example configured as above runs in a hybrid driving mode (HV drive mode) for driving with the operation of engine 22 and the motors MG1, MG2 or an electric driving mode (EV drive mode) for driving without operating the engine 22.

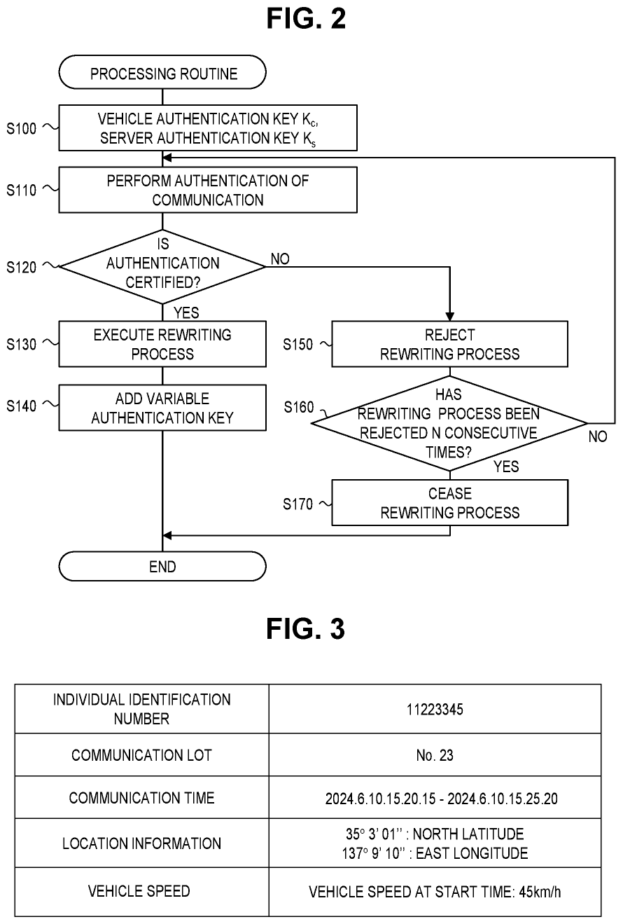

Hereinbelow, the operations of the cloud server 90 and the hybrid vehicle 20 equipped with the in-vehicle control device of the present example configured as above, in particular, the operation when the communication is established between the ECU 70 and the cloud server 90 via the first GECU 80, will be described. FIG. 2 is a flowchart illustrating one example of a processing routine executed by the ECU 70. This routine is executed when the ECU 70 receives a rewrite command from the cloud server 90 (for example, a rewrite command of the flash memory 78 using data transmitted from the cloud server 90). At this time, the ECU 70 determines that the authentication with the cloud server 90 is requested for a rewriting process.

When the processing routine illustrated in FIG. 2 is executed, the ECU 70 inputs data, such as a vehicle authentication key K_{c} and a server authentication key Kₛ (step S100). The vehicle authentication key K_{c} is a variable authentication key that is set using at least a part of information on previous communication established between the ECU 70 and the cloud server 90. The data stored in the flash memory 78 is input as the vehicle authentication key K_{c}. The server authentication key Kₛ is a variable authentication key that is set using at least a part of the information on the previous communication established between the ECU 70 and the cloud server 90. The data stored in the storage medium 98 is input as the server authentication key Kₛ using the communication from the cloud server 90. Hereinafter, the vehicle authentication key K_{c} and the server authentication key Kₛ may each be referred to as a “variable authentication key”.

FIG. 3 is an explanatory diagram illustrating one example of information included in the variable authentication key. In the example illustrated in FIG. 3, the variable authentication key includes an individual identification number, a communication lot, a communication time, the location information, and the vehicle speed V. The individual identification number is a value stored in advance in the ROM 74, which is used as a number for identifying the hybrid vehicle 20. The communication lot is a value assigned to identify the communication established between the ECU 70 and the cloud server 90 (the vehicle authentication key K_{c} or the server authentication key Kₛ). A start time and an end time of the communication are used as the communication time. The location information refers to latitude and longitude received by the GPS antenna of the navigation device 60. A value detected by the vehicle speed sensor 62 is used as the vehicle speed V. Moreover, the vehicle authentication key K_{c} and the server authentication key Kₛ are set such that the keys sharing the same individual identification number and the same communication lot are the same variable authentication key.

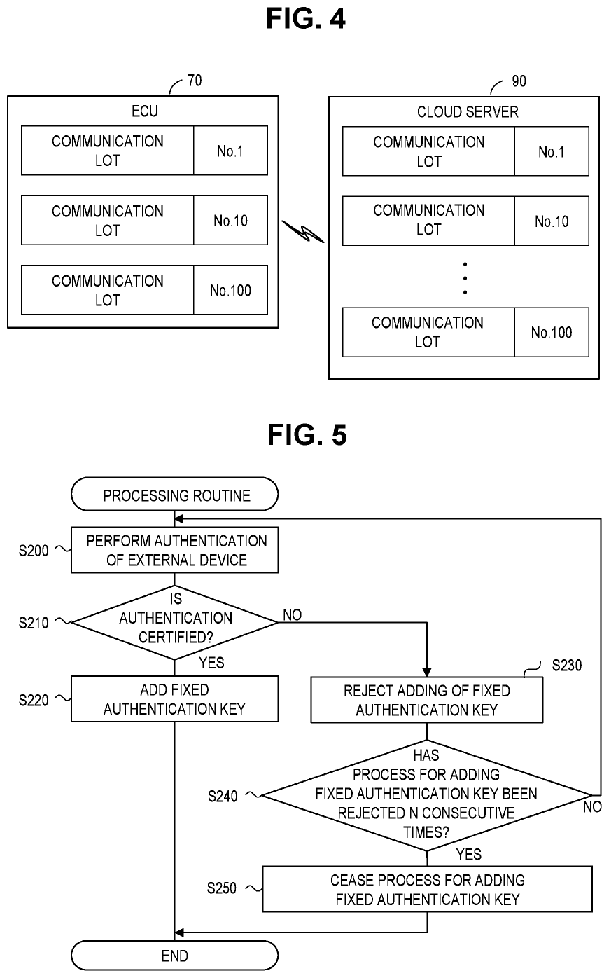

When the data is input as described above, the authentication of the communication with the cloud server 90 is performed (step S110), and it is determined whether it is certified that the communication is authenticated (step S120). The authentication can be performed, for example, by comparing the vehicle authentication key K_{c} with the server authentication key Kₛ. FIG. 4 is an explanatory diagram illustrating one example of a method for authenticating the communication between the ECU 70 and the cloud server 90. In the example of FIG. 4, the vehicle authentication keys K_{c} having the communication lot numbers of 1, 10, and 100 are stored in the ECU 70. On the other hand, the server authentication keys Kₛ having the communication lot numbers of 1 to 100 are stored in the cloud server 90. The cloud server 90 transmits, to the ECU 70, as the server authentication key Kₛ, the latest authentication key (the server authentication keys Kₛ having the communication lot number of 100) from among those (the server authentication key Kₛ having the communication lot numbers of 1, 10, and 100) having the individual identification number corresponding to the hybrid vehicle 20. The cloud server 90 is notified when it is certified that the vehicle authentication key K_{c} having the communication lot number of 100 matches the server authentication key Kₛ. Simultaneously, the cloud server 90 authenticates the communication in the same manner as that of the ECU 70, and the ECU 70 is notified when it is certified that the vehicle authentication key K_{c} matches the server authentication key Kₛ. When both the ECU 70 and the cloud server 90 certify that the vehicle authentication key K_{c} matches the server authentication key Kₛ, the ECU 70 determines that it is certified that the communication with the cloud server 90 is authenticated. Moreover, in a case where the authentication is determined using only the latest vehicle authentication key K_{c} and the latest server authentication key Kₛ, the ECU 70 and the cloud server 90 may store (overwrite) the latest vehicle authentication key K_{c} and the corresponding server authentication key Kₛ (the latest server authentication key Kₛ for the hybrid vehicle 20).

When it is certified that the communication is authenticated in step S120, the rewriting process according to the rewrite command (for example, the rewriting process of the flash memory 78 using the data transmitted from the cloud server 90) is executed (step S130), and the vehicle authentication key K_{c} is added (step S140), and the routine ends. As illustrated in FIG. 3, the vehicle authentication key K_{c} is generated based on the information on the communication established between the ECU 70 and the cloud server 90, and is stored in the flash memory 78. Simultaneously, the cloud server 90 generates the server authentication key Kₛ that is identical to the vehicle authentication key lc, and stores the generated server authentication key Kₛ in the storage medium 98. The vehicle authentication key K_{c} and the server authentication key Kₛ are generated as the variable authentication keys, and the latest ones are stored in the flash memory 78 or the storage medium 98 up to a predetermined number of authentication keys. The vehicle authentication key K_{c} and the server authentication key Kₛ thus stored are used for the authentication of the communication from the next time authentication is requested (step S110 in this routine). Accordingly, the user does not have to certify the validity since the ECU 70 and the cloud server 90 certify each other's validity using the variable authentication keys (the vehicle authentication key K_{c} and the server authentication key Kₛ), whereby it is possible to improve the efficiency of the authentication for the communication established between the ECU 70 and the cloud server 90.

When it is not certified that the communication is authenticated in step S120, the rewriting process described above is rejected (step S150), and it is determined whether the rewriting process has been rejected N consecutive times (step S160). The value N can be a numerical value, such as 3, 5, or 7. When the rewriting process has not been rejected N consecutive times, the routine returns to step S110. While steps S110, S120, S150, and S160 are repeatedly executed, when it is certified that the communication is authenticated in step S120, the processes of steps S130 and S140 are executed, and the routine ends.

While steps S110, S120, S150, and S160 are repeatedly executed, when the rewriting process has been rejected N consecutive times in S160, the rewriting process corresponding to the rewrite command is ceased (step S170), and the routine ends. Consequently, it is possible to prevent the unauthorized process from being executed when the ECU 70 communicates with the cloud server 90. Further, considering that the communication may not be authenticated due to, for example, a communication environment, the rewriting process of the flash memory 78 is ceased when the authentication fails N consecutive times (i.e. the rewriting process is rejected).

Hereinbelow, the operation executed when the second GECU 82 is connected to the external device provided for use by, for example, a dealer, and the ECU 70 and the cloud server 90 store a fixed authentication key K_{d}, will be described. The external device is configured to be capable of being connected to the hybrid vehicle 20 and establishing the wireless communication with the cloud server 90. The fixed authentication key K_{d} is an authentication key used in place of the variable authentication keys (the vehicle authentication key K_{c} and the server authentication key Kₛ) when the communication established between the ECU 70 and the cloud server 90 is authenticated for the first time. FIG. 5 is a flowchart illustrating one example of a processing routine executed by the ECU 70. The routine is executed when a command for adding the fixed authentication key K_{d} is received from the external device.

When the processing routine of FIG. 5 is executed, the ECU 70 authenticates the external device at first (step S200), and determines whether it is certified that the external device is authenticated (step S210). The determination is made by checking whether the external device is for use by, for example, the dealer. When it is certified that the external device is authenticated, the fixed authentication key K_{d} is stored in the flash memory 78 (step S220), and the routine ends. Simultaneously, the cloud server 90 stores the input fixed authentication key K_{d} in the storage medium 98 by the communication from the external device or via the second GECU 82, the ECU 70, and the first GECU 80. The fixed authentication key K_{d} thus stored is used for authentication of the next communication (the processing routine illustrated in FIG. 4). The vehicle authentication key K_{c} and the server authentication key Kₛ are used for the second and subsequent authentications of the communication. Consequently, the authentication is performed using the stored fixed authentication key K_{d} when the communication is established between the ECU 70 and the cloud server 90 for the first time before the sale by the dealer or at the time of maintenance, thus the communication with the cloud server 90 has improved reliability.

When it is not certified that the external device is authenticated in step S200, the process of adding the fixed authentication key K_{d} is rejected (step S230), and it is determined whether the process of adding the fixed authentication key K_{d} has been rejected N consecutive times (step S240). The value N can be a numerical value such as 3, 5, or 7. When the process of adding the fixed authentication key K_{d} has not been rejected N consecutive times, the routine returns to step S200. While steps S200, S210, S230, and S240 are repeatedly executed, when it is certified that the external device is authenticated in step S210, the process of steps S220 is executed, and the routine ends.

While steps S200, S210, S230, and S240 are repeatedly executed, when the process of adding the fixed authentication key K_{d} has been rejected N consecutive times in S240, the process of adding the fixed authentication key K_{d} is ceased (step S250), and the routine ends. Accordingly, it is possible to prevent an unauthorized addition of the fixed authentication key K_{d}, and improve the reliability of the fixed authentication key K_{d}.

In the in-vehicle control device (mainly the ECU 70) mounted on the hybrid vehicle 20, which is illustrated in the present example described above, when the authentication is requested upon executing the predetermined process (for example, the rewriting process of the flash memory 78) involving the communication with the cloud server 90, the authentication is performed using the vehicle authentication key K_{c} and the server authentication key Kₛ. When the authentication using the vehicle authentication key K_{c} and the server authentication key Kₛ is certified, the in-vehicle control device executes the predetermined process and stores, as the vehicle authentication key K_{c}, at least a part of the information on the communication upon executing the predetermined process. Accordingly, the user does not have to certify the validity since the ECU 70 and the cloud server 90 certify each other's validity using the variable authentication keys (the vehicle authentication key K_{c} and the server authentication key Kₛ), whereby it is possible to improve the efficiency of the authentication for the communication established between the hybrid vehicle 20 and the cloud server 90.

In the in-vehicle control device of the present example, the vehicle authentication key K_{c} and the server authentication key Kₛ respectively include the individual identification number, the communication lot, the communication time, the location information, and the vehicle speed V, as illustrated in the drawings. However, the vehicle authentication key K_{c} and the server authentication key Kₛ may not include some of these pieces of data, or may include, instead of or in addition to some or all of these pieces of data, processing information on the predetermined process or other information on the communication.

In the in-vehicle control device of the present example, the authentication of the communication is certified when the previous vehicle authentication key K_{c} (the latest one from among a plurality of the vehicle authentication keys K_{c}) matches the corresponding server authentication key Kₛ. However, the authentication of the communication may be certified when all of the vehicle authentication keys K_{c} respectively match the corresponding server authentication keys Kₛ. Accordingly, the reliability of the communication can be improved. Moreover, the reliability of the communication can be evaluated based on the number of variable authentication keys used for certifying the authentication. In this case, when it is certified that the communication is authenticated, items that can be rewritten may be limited based on the number of the vehicle authentication keys K_{c} used for the authentication of the communication. Consequently, the rewriting process of the important items (for example, a control program of the engine 22 or the motors MG1, MG2, related to the driving) can be prohibited when the communication has low reliability.

In the in-vehicle control device of the present example or a modified example, the authentication of the communication is certified when the predetermined number of the vehicle authentication keys K_{c} match the corresponding server authentication keys Kₛ regardless of features of the rewriting process. However, the authentication of the communication may be certified when the number of vehicle authentication keys K_{c} respectively match the corresponding server authentication keys Kₛ when the number is set to correspond to the features of the rewriting process. Consequently, the rewriting process of the important items (for example, a control program of the engine 22 or the motors MG1, MG2, related to the driving) can be prohibited in an environment in which the communication has low reliability. Additionally, it is possible to prevent the rewriting process of relatively unimportant items (for example, a control program of the contents displayed on the display of the navigation device 60) from being unnecessarily prohibited.

In the in-vehicle control device of the present example, the rewriting process is ceased when the authentication fails (the rewriting process is rejected) N consecutive times. However, the rewriting process may be ceased if the authentication fails only once.

The in-vehicle control device of the present example includes the ECU 70, the first GECU 80, and the second GECU 82. However, at least two of those components may be configured as a single electronic control unit.

In the in-vehicle control device of the present example, the ECU 70 is installed in the hybrid vehicle that is driven by the driving force of the engine 22 and/or the motors MG1, MG2. However, it may be mounted in the electric vehicle that is driven by the driving force of the motor only, or may be mounted in an automobile that is driven by the driving force of the engine only.

For the main elements of the present example and the main elements of the present disclosure described in “SUMMARY”, the present example is one example for specifically illustrating the embodiment for carrying out the present disclosure described in “SUMMARY”; thus the elements of the present disclosure described in “SUMMARY” are not limited to the present example. In other words, the present disclosure described in the “SUMMARY” should be interpreted based on the recitations of such a section, and the present example is merely a specific example of the present disclosure described in the “SUMMARY”.

Although the embodiments for carrying out the present disclosure have been described referring to the examples, an applicable embodiment of the present disclosure is not limited to those examples, and various embodiments not departing from the scope thereof.

The present disclosure can be employed in manufacturing of in-vehicle control devices.

What is claimed is:

1. An in-vehicle control device that communicates with an external communication server, wherein the in-vehicle control device is configured to:
when authentication is requested upon executing a predetermined process involving the communication with the external communication server, perform the authentication using a variable authentication key; and
when the authentication using the variable authentication key is certified, execute the predetermined process and store, as the variable authentication key, at least a part of information on the communication upon executing the predetermined process.

2. The in-vehicle control device according to claim 1, wherein the variable authentication key is information including at least one of vehicle location information, a communication time with the external communication server, and processing information on the predetermined process.

3. The in-vehicle control device according to claim 1, wherein the in-vehicle control device is configured to store a plurality of variable authentication keys.

4. The in-vehicle control device according to claim 1, wherein the in-vehicle control device is configured to cease the execution of the predetermined process when the authentication is not able to be certified a predetermined number of times.

5. The in-vehicle control device according to claim 1, wherein the in-vehicle control device is configured to store a fixed authentication key at least until shipment of a vehicle, and perform authentication using the fixed authentication key when the authentication with the external communication server is requested for a first time.

6. The in-vehicle control device according to claim 5, wherein the in-vehicle control device is configured to, upon receiving a predetermined command from an external device, store the fixed authentication key.
